(19) United States
(12) Patent Application Publication
(10) Pub. No.: US 2026/0078725 A1
(43) Pub. Date: Mar. 19, 2026

(54) OFF-ROAD VEHICLE

(71) Applicant: KAWASAKI MOTORS, LTD., Hyogo (JP)

(72) Inventor: Kengo SHIMATANI, Akashi-shi (JP)

(73) Assignee: KAWASAKI MOTORS, LTD., Hyogo (JP)

(21) Appl. No.: 19/273,130

(22) Filed: Jul. 18, 2025

(30) Foreign Application Priority Data
Sep. 19, 2024 (JP) 2024-162555

(51) Int. Cl. F02M 35/02; B60K 13/02; F02M 35/024; F02M 35/16

(52) U.S. Cl. CPC F02M 35/0201; F02M 35/02416; F02M 35/161; F02M 35/162; B60K 13/02

(57) ABSTRACT

An air cleaner includes: an air cleaner case defining an internal space; and an air cleaner element accommodated in the air cleaner case and including an air filter that divides the internal space into a dirty region and a clean region. The air cleaner case includes: an inner surface defining the internal space; an inflow opening located on the inner surface and facing the air filter through the dirty region; and an outflow opening facing the clean region. The air filter extends in a predetermined direction. The inflow opening has a shape extending in the predetermined direction.

### CROSS-REFERENCE TO RELATED APPLICATION

This application claims priority to and the benefit of Japanese Patent Application No. 2024-162555 filed on Sep. 19, 2024, the entire disclosure of which is incorporated herein by reference.

### BACKGROUND OF THE INVENTION

### Field of the Invention

The present disclosure relates to an off-road vehicle including an air cleaner.

### Description of the Related Art

An off-road vehicle including an internal combustion engine includes an intake passage that supplies outside air to the internal combustion engine for combustion. An off-road vehicle including a continuously variable transmission includes an intake passage that supplies outside air to the continuously variable transmission for cooling. An air cleaner that purifies the air may be located on each of these intake passages.

US 2022/0152545 A1 discloses an air cleaner located on an intake passage of a vehicle. The air cleaner includes an air cleaner case and an air filter accommodated in the air cleaner case. The air filter divides an internal space of the air cleaner case into a dirty region and a clean region. An intake duct located upstream of the air cleaner communicates with the dirty region of the internal space of the air cleaner case, and an intake duct located downstream of the air cleaner communicates with the clean region of the internal space of the air cleaner case.

The air filter inevitably acts as resistance to the flow of intake air. However, smooth intake is desired to improve the performance of the internal combustion engine or the continuously variable transmission. Moreover, to maintain the purifying performance of the air cleaner, it is desirable that the intake air flow uniformly through the air filter.

### SUMMARY OF THE INVENTION

An object of one aspect of the present disclosure is to enhance the performance of an off-road vehicle by improving an air cleaner.

An off-road vehicle according to one aspect of the present disclosure includes: an intake duct defining a dirty passage; and an air cleaner connected to the intake duct. The air cleaner includes: an air cleaner case defining an internal space; and an air cleaner element accommodated in the air cleaner case and including an air filter that divides the internal space into a dirty region and a clean region. The air cleaner case includes: an inner surface defining the internal space; an inflow opening located on the inner surface and facing the air filter through the dirty region; and an outflow opening facing the clean region. The air filter extends in a predetermined direction. The inflow opening has a shape extending in the predetermined direction.

An off-road vehicle according to another aspect of the present disclosure includes: an intake duct defining a dirty passage; and an air cleaner connected to the intake duct. The air cleaner includes: an air cleaner case defining an internal space; and an air cleaner element accommodated in the air cleaner case and including an air filter that divides the internal space into a dirty region and a clean region. The air cleaner case includes: an inner surface defining the internal space; an inflow opening located on the inner surface and facing the air filter through the dirty region; and an outflow opening facing the clean region. The air filter extends in a predetermined direction. A size of the inflow opening in the predetermined direction is larger than half a size of the air filter in the predetermined direction.

### BRIEF DESCRIPTION OF THE DRAWINGS

FIG. 1 is a right side view of an off-road vehicle according to an embodiment.

FIG. 2 is a perspective view of an intake structure of the off-road vehicle of FIG. 1 as viewed from a rear-right side of the off-road vehicle.

FIG. 3 is a perspective view of the intake structure of FIG. 2 as viewed from an inside in a vehicle width direction.

FIG. 4 is a side view showing an air cleaner and the like shown in FIG. 2.

FIG. 5 is a longitudinal sectional view of the air cleaner of FIG. 4.

FIG. 6 is a side view of the air cleaner of FIG. 5 as viewed in a direction facing an inlet tubular portion.

FIG. 7 is a perspective view of a rear portion of the off-road vehicle of FIG. 1 as viewed from a rear-right side of the off-road vehicle.

FIG. 8A is a sectional view showing a fastener for a first protective cover. FIG. 8B is a sectional view showing an engagement structure for a second protective cover.

FIG. 9 is a longitudinal sectional view of the air cleaner according to Modified Example.

### DETAILED DESCRIPTION

Hereinafter, an embodiment will be described with reference to the drawings. Unless otherwise specified, the directions mentioned in the following description are based on the directions of an off-road vehicle 1. A front-rear direction corresponds to a vehicle lengthwise direction, and a left-right direction corresponds to a vehicle width direction.

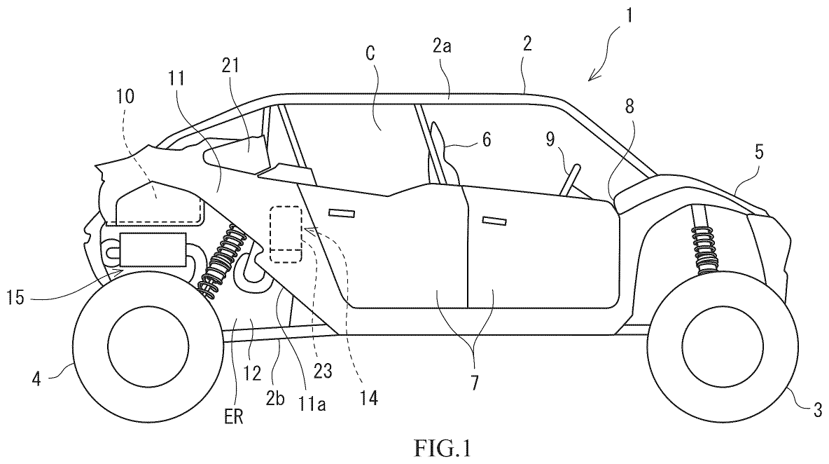

FIG. 1 is a right side view of the off-road vehicle 1 according to the embodiment. As shown in FIG. 1, the off-road vehicle 1 includes: a vehicle body frame 2; a pair of front wheels 3 that are left and right front wheels and support a front portion of the vehicle body frame 2; and a pair of rear wheels 4 that are left and right rear wheels and support a rear portion of the vehicle body frame 2. The vehicle body frame 2 is a pipe frame including pipes connected to each other. Tires for the front wheels 3 and the rear wheels 4 are balloon tires for irregular ground traveling. A space between the left and right front wheels 3 is covered with a front cover 5 from above.

An occupant seat 6 supported by the vehicle body frame 2 is located behind the front cover 5. The vehicle body frame 2 includes, for example, a cabin frame 2a surrounding a cabin C in which the occupant seat 6 is located. The cabin C is exposed to the outside. A side door 7 is located at a lateral side of the cabin C. A dashboard 8 is located in front of the occupant seat 6. A steering wheel 9 is located at the dashboard 8.

A cargo bed 10 supported by a rear frame 2b of the vehicle body frame 2 is located behind the cabin frame 2a. The cargo bed 10 defines a recessed loading space that is open to the outside. A prime mover room ER is located behind the cabin frame 2a and under the cargo bed 10. The prime mover room ER is partially covered with a rear side cowl 11 that is exposed outward in the vehicle width direction to the outside. The rear side cowl 11 is supported by the rear frame 2b of the vehicle body frame 2.

An internal combustion engine 12 and a continuously variable transmission are located in the prime mover room ER. The internal combustion engine 12 serves as a prime mover, and the continuously variable transmission changes the speed of the driving force output from the internal combustion engine 12. The internal combustion engine 12 is supported by the rear frame 2b. The internal combustion engine 12 is located at a substantially middle portion of the off-road vehicle 1 in the vehicle width direction. An intake system 14 is connected to an intake port of the internal combustion engine 12. An exhaust system 15 is connected to an exhaust port of the internal combustion engine 12. An intake box 21 included in the intake system 14 is located behind the cabin C and in front of the cargo bed 10. The intake box 21 is located higher than the side door 7.

An air cleaner 23 included in the intake system 14 is located lower than the intake box 21. The air cleaner 23 is covered with the rear side cowl 11 from the outside in the vehicle width direction and is hidden in a side view of the off-road vehicle 1. To be specific, in the side view of the off-road vehicle 1, the rear side cowl 11 overlaps the air cleaner 23. The air cleaner 23 is located higher than the rear wheels 4. The intake box 21 and the air cleaner 23 are located at one side of the off-road vehicle 1 in the vehicle width direction. For example, the intake box 21 and the air cleaner 23 are located at a right side of the off-road vehicle 1. The rear side cowl 11 includes a cutout portion 11a through which the prime mover room ER is partially exposed to the outside in the vehicle width direction.

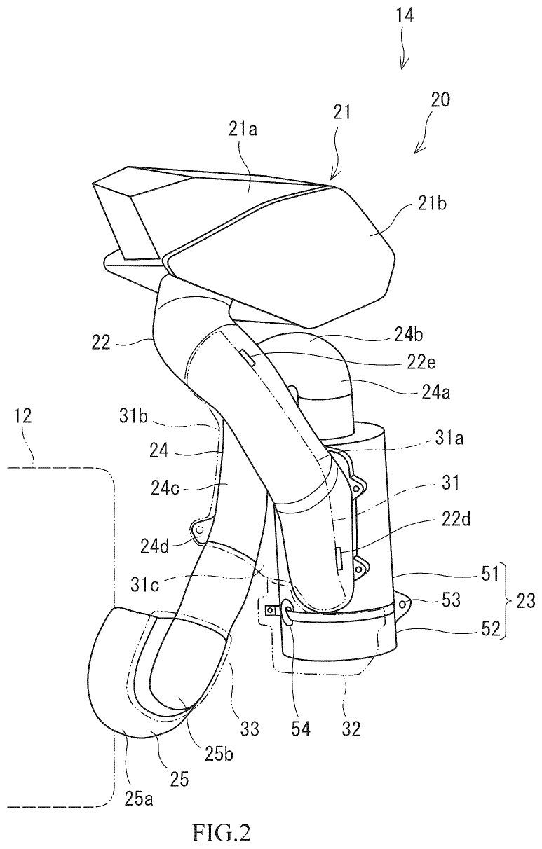

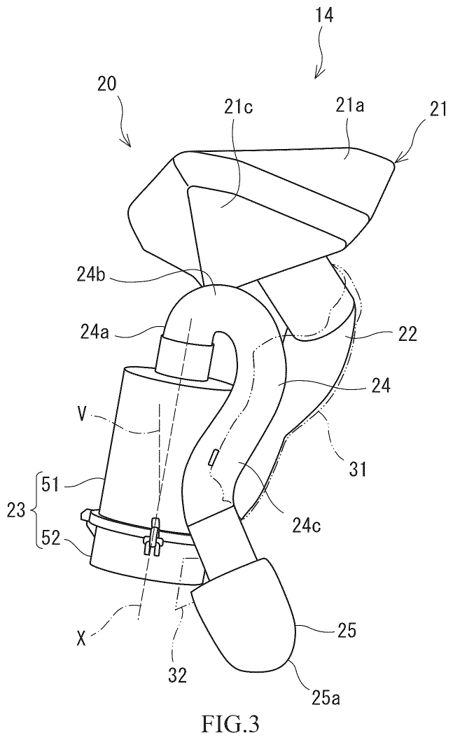

FIG. 2 is a perspective view of an intake structure 20 of the off-road vehicle 1 of FIG. 1 as viewed from a rear-right side of the off-road vehicle 1. FIG. 3 is a perspective view of the intake structure 20 of FIG. 2 as viewed from an inside in the vehicle width direction. As shown in FIGS. 2 and 3, the intake structure 20 included in the intake system 14 includes the intake box 21, a first intake duct 22, the air cleaner 23, a second intake duct 24, and forced induction equipment 25. Intake air from the forced induction equipment 25 is supplied to the intake port of the internal combustion engine 12 through a third intake duct, an intercooler, a fourth intake duct, an intake tank, and a throttle body.

The intake box 21 includes a box 21a and filters 21b and 21c attached to the box 21a. The box 21a defines an internal space and includes two openings that exposes the internal space to the outside. The filters 21b and 21c close the respective openings of the box 21a. By negative pressure generated at the intake port of the internal combustion engine 12, outside air is drawn as the intake air into the internal space of the intake box 21 through the filters 21b and 21c. The filters 21b and 21c roughly remove foreign matter from the intake air at an upstream side of the air cleaner 23.

The intake air in the intake box 21 flows through the first intake duct 22, the air cleaner 23, the second intake duct 24, and the forced induction equipment 25 in this order. The intake box 21 is connected to the air cleaner 23 through the first intake duct 22. The first intake duct 22 defines a dirty passage through which the intake air which has not been purified yet by the air cleaner 23 flows. The first intake duct 22 includes a resin duct.

The air cleaner 23 has a cylindrical shape including an axis X. When viewed in a horizontal direction, the axis X of the air cleaner 23 extends substantially upward at an angle of less than 45°, preferably less than 30° with respect to a vertical line V. Thus, the air cleaner 23 can have a shape extending in a vertical direction, and therefore, an occupied space of the air cleaner 23 in the off-road vehicle 1 in the horizontal direction is reduced. Details of the first intake duct 22 and the air cleaner 23 will be described later.

The air cleaner 23 is connected to the forced induction equipment 25 through the second intake duct 24. The forced induction equipment 25 is located lower than the air cleaner 23. The forced induction equipment 25 is located at a height that overlaps the internal combustion engine 12. The forced induction equipment 25 is located adjacent to the internal combustion engine 12. The forced induction equipment 25 is, for example, mechanical forced induction equipment that is driven by the force extracted from the internal combustion engine 12. The forced induction equipment 25 includes a housing portion 25a and an inlet cover portion 25b. The housing portion 25a accommodates an impeller. The inlet cover portion 25b is fixed to the housing portion 25a so as to cover an intake inlet of the housing portion 25a. The housing portion 25a is made of metal. The inlet cover portion 25b is made of resin. The forced induction equipment 25 may be a turbocharger that is driven by exhaust from the internal combustion engine 12.

The second intake duct 24 defines a clean passage through which the intake air which has already been purified by the air cleaner 23 flows. The second intake duct 24 is located at a height that overlaps a height range of the first intake duct 22. The second intake duct 24 overlaps the first intake duct 22 from the inside in the vehicle width direction. The second intake duct 24 includes a first portion 24a, a second portion 24b, and a third portion 24c.

The first portion 24a of the second intake duct 24 projects upward from the air cleaner 23. The second portion 24b of the second intake duct 24 curves downward from the first portion 24a. To be specific, the second portion 24b has an inverted U shape. The third portion 24c extends from the second portion 24b toward the forced induction equipment 25. The first portion 24a, the second portion 24b, and an upper portion of the third portion 24c are made of resin. A lower portion of the third portion 24c is made of metal.

The intake structure 20 is partially covered with at least one protective cover. The at least one protective cover covers at least the second intake duct 24 defining the clean passage. In the present embodiment, the intake structure 20 is partially covered with a first protective cover 31, a second protective cover 32, and a third protective cover 33. The protective covers 31 to 33 are located between the rear wheel 4 and the intake structure 20. Details of the protective covers 31 to 33 will be described later.

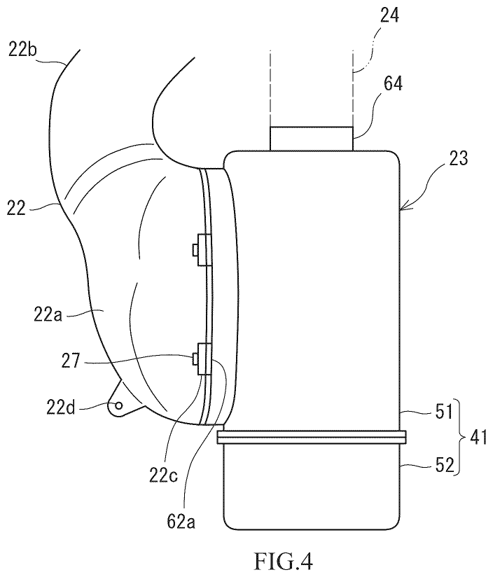

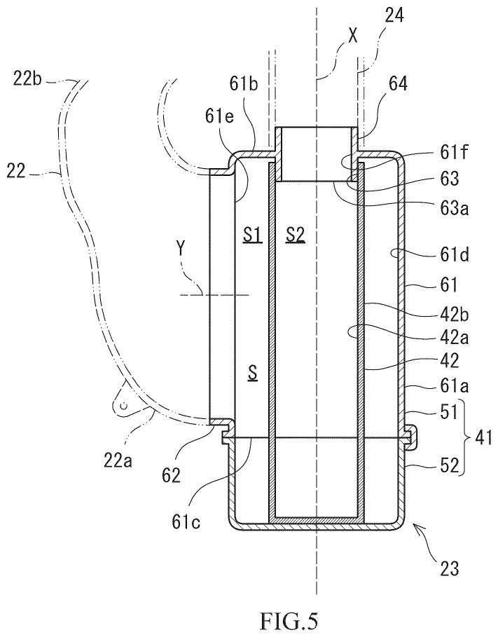

FIG. 4 is a side view showing the air cleaner 23 and the like shown in FIG. 2. FIG. 5 is a longitudinal sectional view of the air cleaner 23 of FIG. 4. As shown in FIGS. 4 and 5, the air cleaner 23 includes an air cleaner case 41 and an air cleaner element 42. The air cleaner element 42 includes a support 42a and an air filter 42b. The support 42a has a mesh shape and a cylindrical outer shape. The air filter 42b is supported by the support 42a and has a cylindrical shape. The air cleaner element 42 is accommodated in the air cleaner case 41.

An internal space S of the air cleaner case 41 is divided by the air filter 42b of the air cleaner element 42 into a dirty region S1 and a clean region S2. To be specific, a region of the internal space S which is located upstream of the air cleaner element 42 is the dirty region S1, and a region of the internal space S which is located downstream of the air cleaner element 42 is the clean region S2.

The air cleaner case 41 has a cylindrical shape including the axis X. A direction in which the axis X extends is referred to as an axial direction X. The air cleaner case 41 is made of resin. The air cleaner case 41 includes a case main body 51 and a lid 52. The case main body 51 includes a case portion 61, an inlet tubular portion 62, an inner outlet tubular portion 63, and an outer outlet tubular portion 64.

The case portion 61 includes: a tubular wall portion 61a that is cylindrical and has the axis X; an upper wall portion 61b that closes an upper side of the tubular wall portion 61a; and a maintenance opening 61c that is located at a lower end of the tubular wall portion 61a and exposes the internal space S downward. The maintenance opening 61c has such a shape and size that the air cleaner element 42 can pass through the maintenance opening 61c. The maintenance opening 61c of the case portion 61 is closed by the lid 52 from below. As shown in FIG. 2, the lid 52 is connected to the case main body 51 through a hinge 53. The lid 52 is locked to the case main body 51 by a lock 54 while closing the maintenance opening 61c. A worker can open the lid 52 by manually releasing the lock 54.

The tubular wall portion 61a of the case portion 61 includes an inner peripheral surface 61d that defines the internal space S and faces an outer peripheral surface of the air filter 42b. The axis X of the case portion 61 coincides with the axis X of the air cleaner 23. The tubular wall portion 61a of the case portion 61 includes an inflow opening 61e located on the inner peripheral surface 61d. The inflow opening 61e faces the air filter 42b through the dirty region S1. The axis X of the air filter 42b coincides with the axis X of the air cleaner 23. The dirty region S1 is defined between the inner peripheral surface 61d of the case portion 61 and the outer peripheral surface of the air filter 42b.

The inlet tubular portion 62 projects from the tubular wall portion 61a of the case portion 61 to the outside. The inlet tubular portion 62 defines a passage communicating with the inflow opening 61e of the case portion 61. A passage axis Y of the inlet tubular portion 62 extends in a direction intersecting with the axis X of the case portion 61. A direction in which the passage axis Y extends may be referred to as a passage axial direction Y. The first intake duct 22 is connected to the inlet tubular portion 62.

The inlet tubular portion 62 includes a tab 62a projecting from an outer surface of the inlet tubular portion 62. The first intake duct 22 includes a tab 22c that matches the tab 62a of the inlet tubular portion 62. The tab 62a of the inlet tubular portion 62 and the tab 22c of the first intake duct 22 are fastened to each other by a fastener 27.

The upper wall portion 61b of the case portion 61 includes an outlet 61f. The inner outlet tubular portion 63 projects from the upper wall portion 61b toward the internal space S and defines a passage communicating with the outlet 61f. A lower end of the inner outlet tubular portion 63 includes an outflow opening 63a facing the clean region S2. The outflow opening 63a faces the clean region S2 and communicates with the clean passage of the second intake duct 24. The outflow opening 63a is located at an upper side of the case main body 51 in the axial direction X, and the maintenance opening 61c is located at a lower side of the case main body 51 in the axial direction X. The area of the inflow opening 61e is larger than the area of the outflow opening 63a.

The outer outlet tubular portion 64 is coaxial with the inner outlet tubular portion 63, projects from the upper wall portion 61b to the outside, and defines a passage communicating with the outlet 61f. The second intake duct 24 is connected to the outer outlet tubular portion 64. The inner outlet tubular portion 63 and the outer outlet tubular portion 64 are located at an upper portion of the case main body 51. The axis X of the inner outlet tubular portion 63 and the outer outlet tubular portion 64 coincides with the axis X of the case portion 61. The outlet 61f has a true circular shape, and each of the inner outlet tubular portion 63 and the outer outlet tubular portion 64 has a true cylindrical shape.

The air cleaner element 42 has a bottomed tubular shape that is open upward. An upper end portion of the air cleaner element 42 is fitted to the inner outlet tubular portion 63 in the axial direction X. The inner outlet tubular portion 63 serves as an element support portion supporting the air cleaner element 42. The air cleaner element 42 is accommodated in the air cleaner case 41 so as to be spaced apart from a cylindrical inner peripheral surface of the case main body 51. To be specific, the dirty region S1 has a section that is annular about the axis X. The clean region S2 is defined by an inner peripheral surface of the air filter 42b.

The intake air which has flowed from the first intake duct 22 into the inlet tubular portion 62 flows from the inflow opening 61e into the internal space S, diffuses in the dirty region S1, and flows through the air filter 42b into the clean region S2. The intake air in the clean region S2 flows out from the outflow opening 63a to the second intake duct 24.

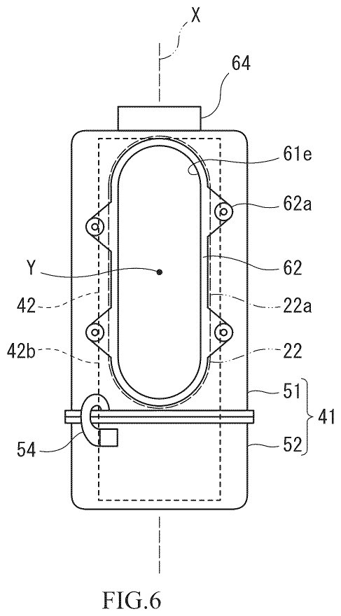

FIG. 6 is a side view of the air cleaner 23 of FIG. 5 as viewed in a direction facing the inlet tubular portion 62. As shown in FIG. 6, when viewed in the passage axial direction Y of the inlet tubular portion 62, the inlet tubular portion 62 has a shape extending in the axial direction X. When viewed in a direction facing the inflow opening 61e, the inflow opening 61e of the case portion 61 has a shape extending in the axial direction X. To be specific, when viewed in such a direction that the area of the inflow opening 61e appears the largest, each of the inner peripheral surface of the inlet tubular portion 62 and the inflow opening 61e of the case portion 61 has a shape extending in the axial direction X.

When viewed in the passage axial direction Y of the inflow opening 61e, the inflow opening 61e extends in a direction in which the air filter 42b extends. The direction in which the inflow opening 61e extends does not have to completely coincide with the direction in which the air filter 42b extends, and may be slightly offset from the direction in which the air filter 42b extends. When viewed in the direction facing the inflow opening 61e, the inflow opening 61e has an oval shape including a major axis extending in the axial direction X. Similarly, when viewed in the passage axial direction Y of the inlet tubular portion 62, the inner peripheral surface of the inlet tubular portion 62 also has an oval shape including a major axis extending in the axial direction X. The air filter 42b extends in the axial direction X. The shape of the inflow opening 61e is not limited to the oval shape. When viewed in the direction facing the inflow opening 61e, the inflow opening 61e may have an elliptical shape including a major axis extending in the axial direction X.

The size of the inflow opening 61e in the axial direction X is larger than half the size of the air filter 42b in the axial direction X. Preferably, the size of the inflow opening 61e in the axial direction X is 65% or more and 80% or less of the size of the air filter 42b in the axial direction X. When the inflow opening 61e has the above size in the axial direction X, the inflow opening 61e may have a true circular shape when viewed in the direction facing the inflow opening 61e.

The first intake duct 22 includes a downstream portion 22a and an upstream portion 22b. The downstream portion 22a is coupled to the inlet tubular portion 62. The upstream portion 22b is located upstream of the downstream portion 22a in an intake flow direction of the first intake duct 22. A passage axis of an outlet of the downstream portion 22a of the first intake duct 22 coincides with the passage axis Y of the inlet tubular portion 62. The outlet of the downstream portion 22a of the first intake duct 22 has an oval shape that matches the inlet tubular portion 62, that is, a shape extending in the axial direction X when viewed in the passage axial direction Y. An inlet of the upstream portion 22b of the first intake duct 22 has a true circular shape.

A sectional shape of the first intake duct 22 changes from an upstream side of the first intake duct 22 to a downstream side of the first intake duct 22. The outlet of the downstream portion 22a of the first intake duct 22 is larger than the inlet of the upstream portion 22b of the first intake duct 22. A major-axis inner diameter of the outlet of the downstream portion 22a of the first intake duct 22 is larger than an inner diameter of the inlet of the upstream portion 22b of the first intake duct 22. A passage sectional area of the downstream portion 22a of the first intake duct 22 gradually increases toward the outlet of the downstream portion 22a. A smallest passage sectional area of the upstream portion 22b of the first intake duct 22 is larger than a smallest passage sectional area of the second intake duct 24. The smallest passage sectional area of the upstream portion 22b of the first intake duct 22 may be larger than a largest passage sectional area of the second intake duct 24.

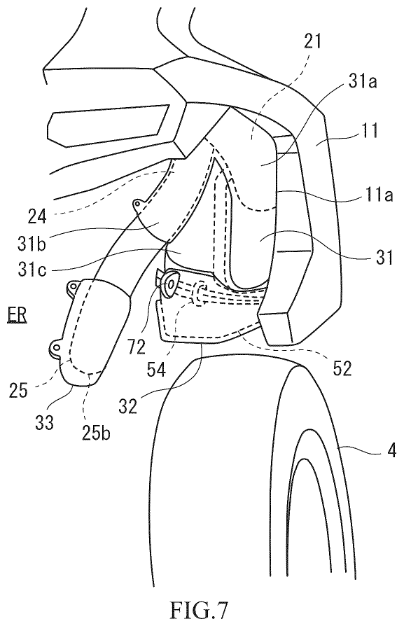

FIG. 7 is a perspective view of a rear portion of the off-road vehicle 1 of FIG. 1 as viewed from a rear-right side of the off-road vehicle 1. As shown in FIG. 7, the air cleaner 23 is covered with the rear side cowl 11 from the outside in the vehicle width direction and is hidden in a side view of the off-road vehicle 1. The rear side cowl 11 includes the cutout portion 11a through which the prime mover room ER is partially exposed to the outside in the vehicle width direction. The off-road vehicle 1 does not include wheel wells opposed to the respective rear wheels 4. If the first to third protective covers 31 to 33 are not included, the intake box 21, the first intake duct 22, the air cleaner 23, the second intake duct 24, and the forced induction equipment 25 are directly opposed to the rear wheel 4. If the first to third protective covers 31 to 33 are not included, the lid 52 of the air cleaner 23 and the lock 54 are exposed when viewed from an obliquely lateral rear side of the off-road vehicle 1.

The first to third protective covers 31 to 33 are located between the rear wheel 4 and the intake structure 20. Therefore, the intake structure 20 is protected from, for example, stones kicked up by the rear wheel 4. The first to third protective covers 31 to 33 are located away from the rear side cowl 11. The first to third protective covers 31 to 33 are made of resin.

As shown in FIGS. 2 and 7, the first protective cover 31 is a one-piece plate and collectively covers the first intake duct 22, the air cleaner 23, and the second intake duct 24 from a rear side of the off-road vehicle 1. The first protective cover 31 does not exist in front of the first intake duct 22, the air cleaner 23, and the second intake duct 24 in the front-rear direction of the off-road vehicle 1. To be specific, the first protective cover 31 does not cover the first intake duct 22, the air cleaner 23, and the second intake duct 24 from a front side of the off-road vehicle 1. The first protective cover 31 includes a first intake duct protective portion 31a covering the first intake duct 22, a second intake duct protective portion 31b covering the second intake duct 24, and a bridge portion 31c covering the air cleaner 23.

The first intake duct protective portion 31a has a curved shape along an outer peripheral surface of the first intake duct 22. A gap between the first intake duct protective portion 31a and the first intake duct 22 has a value within a range of 1 mm or more and 5 mm or less. When the gap between the first intake duct protective portion 31a and the first intake duct 22 is 1 mm or more, tolerance can be absorbed. When the gap between the first intake duct protective portion 31a and the first intake duct 22 is 5 mm or less, foreign matter can be suitably prevented from entering the gap.

The second intake duct protective portion 31b has a curved shape along an outer peripheral surface of the second intake duct 24. The second intake duct protective portion 31b covers a resin portion of the second intake duct 24 and does not cover a metal portion that is a downstream portion of the second intake duct 24. A gap between the second intake duct protective portion 31b and the second intake duct 24 has a value within a range of 1 mm or more and 5 mm or less. When the gap between the second intake duct protective portion 31b and the second intake duct 24 is 1 mm or more, tolerance can be absorbed. When the gap between the second intake duct protective portion 31b and the second intake duct 24 is 5 mm or less, foreign matter can be suitably prevented from entering the gap.

The bridge portion 31c couples the first intake duct protective portion 31a to the second intake duct protective portion 31b. The bridge portion 31c covers part of the air cleaner 23. The bridge portion 31c has a flatter shape than the first intake duct protective portion 31a and the second intake duct protective portion 31b.

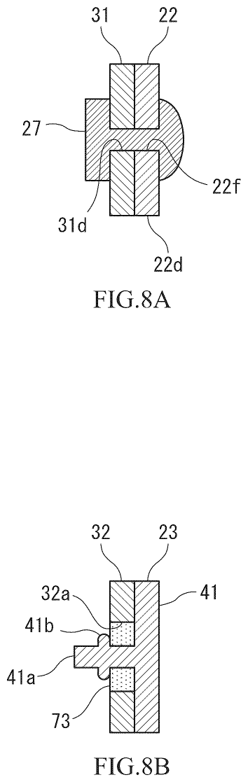

At least part of the first protective cover 31 is attached to the intake structure 20. Specifically, the first protective cover 31 is fixed to: the tab 22d projecting from an outer peripheral surface of the downstream portion 22a of the first intake duct 22; a tab 22e projecting from an outer peripheral surface of the upstream portion 22b of the first intake duct 22; and a tab 24d projecting from an outer peripheral surface of the second intake duct 24. Specifically, as shown in FIG. 8A, the first protective cover 31 includes a fastening hole 31d that coincides with a fastening hole 22f of the tab 22d. The fastener 27 is, for example, a rivet but may be a bolt or the like. The fastener 27 fixes the first protective cover 31 to the first intake duct 22 by being inserted through the fastening hole 31d of the first protective cover 31 and the fastening hole 22f of the first intake duct 22. The first protective cover 31 may also be fixed to the vehicle body frame 2 by a fastener.

The second protective cover 32 covers the lid 52 of the air cleaner 23 and the lock 54 from the rear side of the off-road vehicle 1. The second protective cover 32 does not exist in front of the lid 52 of the air cleaner 23 in the front-rear direction of the off-road vehicle 1. To be specific, the second protective cover 32 does not cover the lid 52 from the front side of the off-road vehicle 1. The second protective cover 32 is detachably engaged with the air cleaner 23 by a tool-free engagement structure 72. Specifically, as shown in FIG. 8B, the engagement structure 72 includes: a boss portion 41a projecting from the air cleaner case 41 of the air cleaner 23; and an elastic ring 73 fitted to a hole 32a of the second protective cover 32. The elastic ring 73 is, for example, a rubber ring.

A retainer 41b projecting outward in a radial direction of the boss portion 41a is located on an outer peripheral surface of the boss portion 41a. The boss portion 41a is inserted through the elastic ring 73 such that the retainer 41b passes through a center hole of the elastic ring 73. Thus, the second protective cover 32 is engaged with the air cleaner case 41. Therefore, the worker can manually detach the second protective cover 32 without using a tool. Thus, when replacing the air cleaner element 42, the worker can open the lid 52 by manually detaching the second protective cover 32 and manually releasing the lock 54. The engagement structure 72 is not limited to a boss elastic press-fit structure shown in FIG. 8B and may be, for example, a claw locking structure.

The third protective cover 33 covers the inlet cover portion 25b that is included in the forced induction equipment 25 and made of resin. Since the inlet cover portion 25b of the forced induction equipment 25 is located outside the housing portion 25a in the vehicle width direction, the inlet cover portion 25b of the forced induction equipment 25 is covered with the third protective cover 33 from the outside in the vehicle width direction. The third protective cover 33 is detachably fixed to the forced induction equipment 25 by a fastener.

When the intake duct and the exhaust duct are connected to the continuously variable transmission, which changes the speed of the driving force output from the internal combustion engine 12, to cool the continuously variable transmission, and at least one of the intake duct or the exhaust duct directly faces the rear wheel 4, the duct directly facing the rear wheel 4 may be partially covered with at least one protective cover. To be specific, a portion of the duct which directly faces the rear wheel 4 may be covered with at least one protective cover. Moreover, the present embodiment has illustrated a structure in which the intake structure 20 is covered with the three protective covers 31 to 33. However, at least two of the protective covers 31 to 33 may be integrated with each other as a single piece.

According to the above configuration, since the intake air which has flowed from the inflow opening 61e of the air cleaner case 41 into the dirty region S1 spreads evenly along the outer peripheral surface of the air filter 42b, the intake air can relatively uniformly and smoothly flow through the air filter 42b. Therefore, the performance of the off-road vehicle 1 can be improved in terms of the intake.

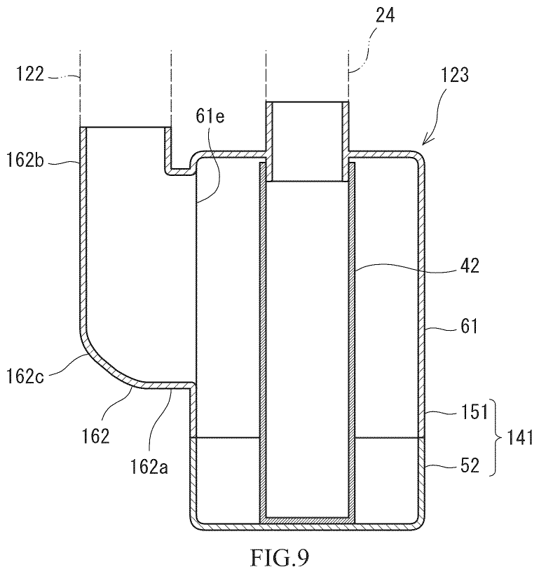

FIG. 9 is a longitudinal sectional view of an air cleaner 123 according to Modified Example. In Modified Example, components that are the same as those in the above embodiment are denoted by the same reference signs, and explanations thereof are omitted. As shown in FIG. 9, a case main body 151 of an air cleaner case 141 of the air cleaner 123 according to Modified Example includes an inlet tubular portion 162 that is different in shape from the inlet tubular portion 62 of the above embodiment. The inlet tubular portion 162 includes an oval tubular portion 162a, a true circular tubular portion 162b, and a transition portion 162c. The oval tubular portion 162a of the inlet tubular portion 162 is a downstream end portion of the inlet tubular portion 162 and has an oval section that is the same as that of the inflow opening 61e of the case portion 61. The true circular tubular portion 162b is an upstream end portion of the inlet tubular portion 162 and has a true circular section. A downstream end of a first intake duct 122 which is connected to the inlet tubular portion 162 has a true circular section. The transition portion 162c has a section that smoothly changes from a true circular shape to an oval shape from an upstream side to a downstream side so as to smoothly connect the true circular tubular portion 162b to the oval tubular portion 162a.

Even in this configuration, the intake air which has flowed from the first intake duct 122 into the inlet tubular portion 162 flows from the inflow opening 61e of the case portion 61 into the dirty region S1 and spreads evenly along the outer peripheral surface of the air filter 42b, and therefore, the intake air can relatively uniformly and smoothly flow through the air filter 42b.

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

### Aspects

The above embodiment has described specific examples of the following aspects.

### First Aspect

An off-road vehicle including:
an intake duct defining a dirty passage; and
an air cleaner connected to the intake duct, wherein:
the air cleaner includes
   an air cleaner case defining an internal space and
   an air cleaner element accommodated in the air cleaner case and including an air filter that divides the internal space into a dirty region and a clean region;
the air cleaner case includes
   an inner surface defining the internal space,
   an inflow opening located on the inner surface and facing the air filter through the dirty region, and
   an outflow opening facing the clean region;
the air filter extends in a predetermined direction; and
the inflow opening has a shape extending in the predetermined direction.

According to this configuration, since the intake air which has flowed from the inflow opening of the air cleaner case into the dirty region spreads in a wide range on the surface of the air filter, the intake air can relatively uniformly and smoothly flow through the air filter. Therefore, the performance of the off-road vehicle can be improved in terms of the intake.

### Second Aspect

The off-road vehicle according to the first aspect, wherein:
the air filter has a tubular shape;
the predetermined direction is an axial direction of the air filter;
the inner surface of the air cleaner case is an inner peripheral surface facing an outer peripheral surface of the air filter;
the clean region is defined by an inner peripheral surface of the air filter; and
the dirty region is defined between the inner peripheral surface of the air cleaner case and the outer peripheral surface of the air filter.

According to this configuration, in the air cleaner that is compact as a whole while increasing the surface area of the air filter, the intake air which has flowed from the inflow opening of the air cleaner case into the dirty region can spread evenly along the outer peripheral surface of the air filter.

### Third Aspect

The off-road vehicle according to the second aspect, wherein when viewed in a horizontal direction, the axial direction is a direction extending at an angle of less than 45° with respect to a vertical line.

According to this configuration, the air cleaner can have a shape extending in the vertical direction, and therefore, the occupied space of the air cleaner in the off-road vehicle in the horizontal direction can be reduced.

### Fourth Aspect

The off-road vehicle according to the second or third aspect, wherein the air cleaner case includes:
a case main body including
   the inflow opening,
   the outflow opening located at one side of the case main body in the axial direction, and
   a maintenance opening located at the other side of the case main body in the axial direction; and
a lid that closes the maintenance opening of the case main body.

According to this configuration, when the lid is opened to expose the maintenance opening of the case, the air cleaner element can be replaced. Moreover, since the inflow opening and the outflow opening are located not on the lid but on the case main body, the intake duct and the lid can be prevented from interfering with each other at the time of the replacement of the air cleaner element.

### Fifth Aspect

The off-road vehicle according to any one of the first to fourth aspects, wherein the inflow opening is larger in area than the outflow opening.

According to this configuration, the flow of the intake air flowing from the inflow opening of the air cleaner case into the dirty region can be made smooth.

### Sixth Aspect

The off-road vehicle according to any one of the first to fifth aspects, wherein:
the air cleaner case includes
   a case portion including the inner surface and
   an inlet tubular portion to which the intake duct is connected and which projects outward from the case portion and defines a passage communicating with the inflow opening;
when viewed in a passage axial direction of the inlet tubular portion, the inlet tubular portion has a shape extending in the predetermined direction;
the intake duct includes a downstream portion coupled to the inlet tubular portion; and
when viewed in a passage axial direction of an outlet of the downstream portion of the intake duct, the downstream portion of the intake duct has a shape extending in the predetermined direction.

According to this configuration, the flow of the intake air flowing from the intake duct to the air cleaner can be made smooth.

### Seventh Aspect

The off-road vehicle according to the sixth aspect, wherein:
the intake duct includes an upstream portion located upstream of the downstream portion in an intake flow direction of the intake duct; and
the outlet of the downstream portion of the intake duct is larger than an inlet of the upstream portion of the intake duct.

According to this configuration, the sectional shape of the intake duct changes from the upstream side of the intake duct to the downstream side of the intake duct. As the intake air approaches the air filter, the intake air can diffuse in a wide range.

### Eighth Aspect

The off-road vehicle according to the seventh aspect, wherein:
the intake duct is a first intake duct;
the off-road vehicle further includes a second intake duct connected to the air cleaner and defining a clean passage; and
a smallest passage sectional area of the upstream portion of the first intake duct is larger than a smallest passage sectional area of the second intake duct.

According to this configuration, the flow of the intake air flowing from the first intake duct into the air cleaner can be made smooth.

### Ninth Aspect

The off-road vehicle according to any one of the first to eighth aspects, wherein a size of the inflow opening in the predetermined direction is larger than half a size of the air filter in the predetermined direction.

According to this configuration, the intake air which has flowed from the inflow opening of the air cleaner case into the dirty region can spread in a wide range on the surface of the air filter.

### Tenth Aspect

The off-road vehicle according to any one of the first to ninth aspects, wherein:
the intake duct is a first intake duct;
the off-road vehicle further includes
   a second intake duct connected to the air cleaner and defining a clean passage and
   at least one protective cover;
the first intake duct, the air cleaner, and the second intake duct are included in an intake structure; and
the at least one protective cover partially covers the intake structure.

According to this configuration, the protective cover can prevent the intake structure from being damaged by something hitting the intake structure.

### Eleventh Aspect

The off-road vehicle according to the tenth aspect, further including a wheel, wherein
the at least one protective cover is located between the wheel and the intake structure.

According to this configuration, the intake structure can be protected from, for example, stones kicked up by the wheel.

### Twelfth Aspect

The off-road vehicle according to the tenth or eleventh aspect, wherein at least part of the at least one protective cover is attached to the intake structure.

According to this configuration, the intake structure can be appropriately covered with the protective cover while preventing the protective cover from increasing in size.

### Thirteenth Aspect

The off-road vehicle according to any one of the tenth to twelfth aspects, wherein:
the at least one protective cover includes a protective cover that is a single piece; and
the protective cover as the single piece covers at least two selected from the group consisting of the first intake duct, the air cleaner, and the second intake duct.

According to this configuration, the protective cover that is the single piece can protect the intake structure in a wide range.

### Fourteenth Aspect

The off-road vehicle according to any one of the tenth to thirteenth aspects, wherein the at least one protective cover has a shape along an outer shape of the intake structure.

According to this configuration, since the gap between the protective cover and the intake structure can be made small as a whole, the intake structure can be suitably protected.

### Fifteenth Aspect

The off-road vehicle according to any one of the tenth to fourteenth aspects, wherein the at least one protective cover includes a protective cover that is detachably engaged with the intake structure by a tool-free engagement structure.

According to this configuration, since the protective cover can be detached without using a tool, the ease of maintenance of the intake structure can be satisfactorily kept.

### Sixteenth Aspect

The off-road vehicle according to any one of the tenth to fifteenth aspects, wherein:
the at least one protective cover includes a first protective cover and a second protective cover;
the first protective cover is fixed to the intake structure by a fastener attached and detached by a tool; and
the second protective cover is detachably engaged with the intake structure by a tool-free engagement structure.

According to this configuration, since the second protective cover can be detached without using a tool while firmly fixing the first protective cover to the intake structure, the ease of maintenance of the air cleaner can be satisfactorily kept.

### Seventeenth Aspect

The off-road vehicle according to the sixteenth aspect, wherein:
the air cleaner case includes
   a case main body including a maintenance opening,
   a lid that closes the maintenance opening of the case main body, and
   a lock that locks the lid to the case main body in a state where the lid closes the maintenance opening of the case main body; and
the second protective cover covers at least one of the lid or the lock.

According to this configuration, since the second protective cover can be easily detached, and the lock of the lid can be released, the ease of maintenance of the air cleaner can be satisfactorily kept.

### Eighteenth Aspect

An off-road vehicle including:
an intake duct defining a dirty passage; and
an air cleaner connected to the intake duct, wherein:
the air cleaner includes
   an air cleaner case defining an internal space and
   an air cleaner element accommodated in the air cleaner case and including an air filter that divides the internal space into a dirty region and a clean region;
the air cleaner case includes
   an inner surface defining the internal space,
   an inflow opening located on the inner surface and facing the air filter through the dirty region, and
   an outflow opening facing the clean region;
the air filter extends in a predetermined direction; and
a size of the inflow opening in the predetermined direction is larger than half a size of the air filter in the predetermined direction.

According to this configuration, since the intake air which has flowed from the inflow opening of the air cleaner case into the dirty region spreads in a wide range on the surface of the air filter, the intake air can uniformly and smoothly flow through the air filter. Therefore, the performance of the off-road vehicle can be improved in terms of the intake.

### Nineteenth Aspect

An off-road vehicle including:
a duct;
an air cleaner; and
at least one protective cover that partially covers the duct or the air cleaner.

According to this configuration, the protective cover can prevent the duct or the air cleaner from being hit and damaged by, for example, stones kicked up by the wheel.

What is claimed is:

1. An off-road vehicle comprising:
an intake duct defining a dirty passage; and
an air cleaner connected to the intake duct, wherein:
the air cleaner includes
an air cleaner case defining an internal space and
an air cleaner element accommodated in the air cleaner case and including an air filter that divides the internal space into a dirty region and a clean region;
the air cleaner case includes
an inner surface defining the internal space,
an inflow opening located on the inner surface and facing the air filter through the dirty region, and
an outflow opening facing the clean region;
the air filter extends in a predetermined direction; and
the inflow opening has a shape extending in the predetermined direction.

2. The off-road vehicle according to claim 1, wherein:
the air filter has a tubular shape;
the predetermined direction is an axial direction of the air filter;
the inner surface of the air cleaner case is an inner peripheral surface facing an outer peripheral surface of the air filter;
the clean region is defined by an inner peripheral surface of the air filter; and
the dirty region is defined between the inner peripheral surface of the air cleaner case and the outer peripheral surface of the air filter.

3. The off-road vehicle according to claim 2, wherein when viewed in a horizontal direction, the axial direction is a direction extending at an angle of less than 45° with respect to a vertical line.

4. The off-road vehicle according to claim 2, wherein the air cleaner case includes:
a case main body including
the inflow opening,
the outflow opening located at one side of the case main body in the axial direction, and
a maintenance opening located at the other side of the case main body in the axial direction; and
a lid that closes the maintenance opening of the case main body.

5. The off-road vehicle according to claim 1, wherein the inflow opening is larger in area than the outflow opening.

6. The off-road vehicle according to claim 1, wherein:
the air cleaner case includes
a case portion including the inner surface and
an inlet tubular portion to which the intake duct is connected and which projects outward from the case portion and defines a passage communicating with the inflow opening;
when viewed in a passage axial direction of the inlet tubular portion, the inlet tubular portion has a shape extending in the predetermined direction;
the intake duct includes a downstream portion coupled to the inlet tubular portion; and
when viewed in a passage axial direction of an outlet of the downstream portion of the intake duct, the downstream portion of the intake duct has a shape extending in the predetermined direction.

7. The off-road vehicle according to claim 6, wherein:
the intake duct includes an upstream portion located upstream of the downstream portion in an intake flow direction of the intake duct; and
the outlet of the downstream portion of the intake duct is larger than an inlet of the upstream portion of the intake duct.

8. The off-road vehicle according to claim 7, wherein:
the intake duct is a first intake duct;
the off-road vehicle further includes a second intake duct connected to the air cleaner and defining a clean passage; and
a smallest passage sectional area of the upstream portion of the first intake duct is larger than a smallest passage sectional area of the second intake duct.

9. The off-road vehicle according to claim 1, wherein a size of the inflow opening in the predetermined direction is larger than half a size of the air filter in the predetermined direction.

10. The off-road vehicle according to claim 1, wherein:
the intake duct is a first intake duct;
the off-road vehicle further includes
a second intake duct connected to the air cleaner and defining a clean passage and
at least one protective cover;
the first intake duct, the air cleaner, and the second intake duct are included in an intake structure; and
the at least one protective cover partially covers the intake structure.

11. The off-road vehicle according to claim 10, further comprising a wheel, wherein
the at least one protective cover is located between the wheel and the intake structure.

12. The off-road vehicle according to claim 10, wherein at least part of the at least one protective cover is attached to the intake structure.

13. The off-road vehicle according to claim 10, wherein:
the at least one protective cover includes a protective cover that is a single piece; and
the protective cover as the single piece covers at least two selected from the group consisting of the first intake duct, the air cleaner, and the second intake duct.

14. The off-road vehicle according to claim 10, wherein the at least one protective cover has a shape along an outer shape of the intake structure.

15. The off-road vehicle according to claim 10, wherein the at least one protective cover includes a protective cover that is detachably engaged with the intake structure by a tool-free engagement structure.

16. The off-road vehicle according to claim 10, wherein:
the at least one protective cover includes a first protective cover and a second protective cover;
the first protective cover is fixed to the intake structure by a fastener attached and detached by a tool; and
the second protective cover is detachably engaged with the intake structure by a tool-free engagement structure.

17. The off-road vehicle according to claim 16, wherein:
the air cleaner case includes
a case main body including a maintenance opening,
a lid that closes the maintenance opening of the case main body, and
a lock that locks the lid to the case main body in a state where the lid closes the maintenance opening of the case main body; and
the second protective cover covers at least one of the lid or the lock.

18. An off-road vehicle comprising:
an intake duct defining a dirty passage; and
an air cleaner connected to the intake duct, wherein:
the air cleaner includes
an air cleaner case defining an internal space and
an air cleaner element accommodated in the air cleaner case and including an air filter that divides the internal space into a dirty region and a clean region;
the air cleaner case includes
an inner surface defining the internal space,
an inflow opening located on the inner surface and facing the air filter through the dirty region, and
an outflow opening facing the clean region;
the air filter extends in a predetermined direction; and
a size of the inflow opening in the predetermined direction is larger than half a size of the air filter in the predetermined direction.

19. An off-road vehicle comprising:
a duct;
an air cleaner; and
at least one protective cover that partially covers the duct or the air cleaner.
